(19) United States
(12) Patent Application Publication
(10) Pub. No.: US 2003/0036924 A1
(43) Pub. Date: Feb. 20, 2003

(54) Inferred specialty system

(75) Inventors: Daniel J. Rosen, Carlisle, MA (US); Thomas Marx, Cambridge, MA (US)

Correspondence Address: HALE AND DORR, LLP, 60 STATE STREET, BOSTON, MA, 02109

(73) Assignee: PharMetrics, Inc.

(21) Appl. No.: 10/084,593

(22) Filed: Feb. 27, 2002

Related U.S. Application Data
(60) Provisional application No. 60/272,669, filed on Mar. 1, 2001.

(51) Int. Cl. G06F 17/60

(52) U.S. Cl. 705/2

(57) ABSTRACT

A system identifies a clinician's specialty by examining procedures performed by that clinician, the diagnoses made by the clinician, and the age and gender of the clinician's patients.

### CROSS REFERENCE TO RELATED APPLICATION

This application claims priority from provisional serial No. 60/272,669, filed Mar. 1, 2001, which is incorporated herein by reference.

### BACKGROUND OF THE INVENTION

Most health care organizations that supply claims data include clinician specialty as a standard variable in their data sets. This information is important for a variety of analytical products such as norms reports and drug utilization analyses. Accurate specialty listings are, however, not universally available.

### SUMMARY OF THE INVENTION

To provide information about specialists when it is otherwise missing, and to test the validity of assigned specialties, an inference engine, referred to here as the PracticeLogic System (PLS), is used to identify clinician specialty. The PLS identifies a clinician's specialty by examining the procedures performed by that clinician, the diagnoses made by the clinician, and the age and gender of the clinician's patients. Clinicians within each specialty tend to make a distinct set of diagnoses, perform a distinct set of procedures, and see a unique population of patients. For example, the claims submitted by an hematologist/oncologist will likely contain a high proportion of procedures and diagnoses relating to cancer, while those of a pulmonologist will not. As another example, it is expected that a pediatrician sees patients who are, on average, significantly younger than the group of patients seen by an internist.

The system and methods described herein allow specialty to be automatically inferred based on a set of rules, and thus improve the reporting and analysis of claims data. Other features and advantages will become apparent from the following detailed description and claims.

### DETAILED DESCRIPTION

The PLS can be utilized in a number of circumstances. A specialty listing may not be available. Some datasets do not list specialty information at all, and datasets that generally list specialty often include a significant number (5-20%) of records with missing values in the specialty field.

The PLS is also used generally for an internal medicine listing because the sub-specialties of physicians certified in internal medicine are generally not available, even though roughly 50% of physicians board certified in internal medicine are also board certified in a sub-specialty (according to data from the American Board of Internal Medicine and the AMA). Using supplied specialty listings in these cases leads to an underestimation of the prevalence of certain specialties, such as cardiology or hematology/oncology.

An analysis of specialty data also shows that radiation oncologists are commonly listed as radiologists. The PLS is used in order to obtain an accurate estimate of these specialties.

The system has the following process steps in the development and application of the PLS:

1. Determining the list of specialties to be included in the PLS.

2. Developing practice pattern measures and specialty identification rules for the PLS.

3. Applying the rules to claims where specialty is unknown, or listed as Internal Medicine or Radiology.

Each data provider may have a unique method for grouping practice areas into a set of listed specialties. In order to bring uniformity to this process the PLS maps each data provider's set into one of 54 categories, although other categories and number of categories could be used. An exemplary set is in Table I, below:

TABLE I

| | |
|---|---|
| Allergy and Immunology | Facility |
| Anesthesiology | Gastroenterology |
| Cardiology | General Practice/Family |
| Cardio-Thoracic Surgery | Practice |
| Chiropractic | General Surgery |
| Dentist | Geriatrics |
| Dermatology | Hematology |
| Emergency Medicine Physician | Hematology/Oncology |
| Endocrinology | Infectious Disease |
| ENT (Otolaryngology) | Internal Medicine |
| Medical Genetics | Physical Medicine And |
| Midwife | Rehabilitation |
| Neonatology | Physical Therapy |
| Nephrology | Physician's Assistant |
| Neurology | Plastic Surgery |
| Neurosurgery | Podiatry |
| Nurse Anesthetist | Psychiatry |
| Nurse Practitioner | Psychology |
| | Pulmonology |
| Obstetrics And Gynecology | Radiation Oncology |
| Occupational Therapy | Radiology |
| Ophthalmology | Registered Nurse |
| Optometry | Rheumatology |
| Orthopedic Surgery | Social Work |
| Orthopedics | Urgent Care Facility |
| Osteopath | Urgent Care Medicine |
| Other Surgery | Urology |
| Pathology | Other (Non-Clinician) |
| Pediatrics | |

The PLS identifies the 33 specialty categories that are most prominent in an integrated outcomes database, although more or less of such categories may be used. Clinicians belonging to one of these groups account for roughly 95% of the groupable records in the integrated outcomes database. These categories are in the following Table II:

TABLE II

| | |
|---|---|
| Allergy And Immunology | Neurosurgery |
| Cardiology | Neurology |
| Chiropractic | Obstetrics And Gynecology |
| Cardio-Thoracic Surgery | Ophthalmology |
| Dentist | Orthopedic Surgery |
| Dermatology | Other Specialist |
| Endocrinology | Pediatrics |
| ENT (Otolaryngology) | Podiatry |
| Emergency Medicine Physician | Psychiatry |
| Facility | Pulmonology |
| Gastroenterology | Radiation Oncology |
| General Practice/Family | Radiology |
| Practice | Rheumatology |
| Hematology/Oncology | General Surgery |
| Infectious Disease | Urology |
| Internal Medicine | |
| Neonatology | Clinician |
| Nephrology | N/A |

The PLS provides specialty identification in 53 clinical practice areas and 4 non-clinician or undefined groupings (Facility, Urgent Care Facility, Other (Non-Clinician) and N/A). A number of these categories deserve special explanation.

N/A: If a listing is unavailable and the PLS cannot identify the provider's practice area, the provider is listed as N/A.

Clinician: A provider is clearly identified as a clinician, but no other information is available.

Other Specialist: A provider is identified as a specialist, but is not as a member of one of the other 32 defined specialty categories included in the PLS.

Other (Non-Clinician): A provider is identified as not being a clinician, but no other information is available.

Other Surgery: A provider is identified as a surgeon, but is not a member of one of the defined surgery categories listed above.

Before developing a rule that will identify a specialty, one creates a set of measures that characterize a particular clinician. For example, it is believed that pediatricians tend to see a high proportion of patients under 18, it is useful to know, for each clinician, the percentage of patients they see who are under 18 years of age. The Up PLS rules are based on the following list of measures, each of which is recorded as a percentage. All of a clinician's records are scored on these measures and the percentage that belong to each category is counted.

### Percentages Based on Demographics

Patients Less Than Age One

Patients Over Age Eighteen

Patients Less Than or Equal to Age Eighteen

### Percentages Based on Procedures (CPT4 and HCPCS Codes)

| | |
|---|---|
| Allergy/Immunology Procedures | Hematology/Oncology |
| Cardiac Surgeries | Procedures |
| Cardiology Procedures | Infectious Disease Procedures |
| Chiropractic Procedures | Nephrology Procedures |
| Dental Procedures | Neurology Procedures |
| Dermatology Procedures | Neurosurgery Procedures |
| Emergency Medicine Procedures | OB/GYN Procedures |
| Endocrinological Procedures | Ophthalmological Procedures |
| ENT (Otolaryngology) | Orthopedic Surgery Procedures |
| Procedures | Podiatry Procedures |
| Gastroenterology Procedures | Psychiatric Procedures |
| | Pulmonology Procedures |
| Radiological Oncology | Surgical (General) Procedures |
| Procedures | Thoracic Procedures |
| Radiological Procedures | Urology Procedures |
| Rheumatology Procedures | |

### Percentages Based on Diagnoses (ICD-9 Codes)

| | |
|---|---|
| Allergy/Immunology Diagnoses | Neurology Diagnoses |
| Cardiac Surgery Diagnoses | Neurosurgery Diagnoses |
| Cardiology Diagnoses | OB/GYN Diagnoses |
| Chiropractic Diagnoses | Ophthalmological Diagnoses |
| Chronic Disease Diagnoses | Orthopedic Surgery Diagnoses |
| Associated with Internal Medicine | Podiatry Diagnoses |
| Critical Care Diagnoses | Psychiatric Diagnoses |
| Dermatology Diagnoses | Pulmonology Diagnoses |
| Emergency Medicine Diagnoses | Radiological Diagnoses |
| Endocrinological Diagnoses | Rheumatology Diagnoses |
| ENT (Otolaryngology) Diagnoses | Surgical (General) Diagnoses |
| Gastroenterology Diagnoses | Thoracic Diagnoses |
| Hematology/Oncology Diagnoses | Urgent Care Diagnoses |
| Infectious Disease Diagnoses | Urology Diagnoses |
| Nephrology Diagnoses | |

The next step is to write a rule that identifies the specialty of a clinician, based upon the clinician measures described above. For example, a rule might state that if greater than 50% of a clinician's procedures are related to neurology, then identify that clinician as a neurologist. The values for these rules can be determined by experts who draw upon knowledge and expertise, and upon detailed analysis of records within an integrated outcomes database. The rules are then refined so that they result in specialty identifications that best match those of data sets that include specialty listings.

In addition, if specialty information is unavailable and the practice pattern rules are unable to identify a specialty, then the specialty may be identified by the provider type field of the claim record.

Having established a set of rules, the PLS then applies this set of rules to all known clinicians within the integrated outcomes database, creating a master record of clinician specialty. The rules are applied to providers in two steps: (1) each clinician is broadly identified as a generalist (e.g. Internal Medicine, Pediatrics, General Practice/Family Practice) or a specialist (e.g. Neurologist, Pulmonologist); and (2) the clinician's measures are then further tested against rules in one of these two broad categories in order to make the final specialty identification.

All clinicians who have submitted claims for greater than 10 services (regardless of the time period during which those services occurred) are included in the master record of clinician specialties. This limit was set because the measures by which the clinician is characterized cannot be computed to a reasonable level of accuracy if a clinician has submitted fewer claims.

The vast majority of prescription records list a non-clinician as a provider—usually a pharmacy is listed. In order to link pharmacy records to providers, and hence to a provider specialty, an Episode Treatment Groups (ETG) methodology is used. A key feature of the ETG methodology is its ability to combine seemingly disparate claims records into clinically meaningful disease episodes. The grouper's fundamental task is to group together all claims relating to the treatment of a single episode of a disease.

Clusters are groups of claims records relating to a single disease episode, for which one clinician is responsible. Each cluster contains one anchor record and any number of linked records. The anchor record is generally a visit to a clinician that diagnoses an illness. The linked records generally refer to tests or procedures ordered and drugs prescribed by that clinician.

The key property of clusters pertinent to the PLS is the fact that one clinician manages all the service activity in a cluster. Therefore the ETG grouper assigns all pharmacy records in a cluster to the clinician who is the listed provider on the anchor record of the cluster. The grouper records this assignment by creating a variable for each record, called the Cluster Provider ID that lists the managing provider responsible for all activity within the cluster.

The Cluster Provider ID generated by the ETG grouper allows the PLS to link pharmacy records with clinicians, even when no clinician is listed on the original pharmacy record. Since it is known that the cluster provider is the responsible clinician for all records within a cluster, a specialty can be assigned to a record based upon the clinician listed as the Cluster Provider. By using this method a provider specialty has been assigned to over 95% of records in the assignee's outcomes database (excluding orphan drug records and ungroupable records).

Where possible, the client-supplied specialty listing is assigned to a particular record. The PLS identified specialty is assigned to a record in one of three cases: (1) no client supplied specialty listing is available; (2) the supplied specialty is Internal Medicine, as noted previously, because the supplied data systematically exclude the sub-specialties of physicians board certified in Internal Medicine; and (3) the supplied specialty is Radiology (supplied data systematically includes the practice of Radiation Oncology under the heading of Radiology, but the PLS, on the other hand, has been designed with the ability to distinguish these two specialties).

The PLS is tested by measuring the degree to which its output agrees with the listed specialty. This is done by testing the PLS on datasets where specialty listings are provided, and comparing the provided listings with the output of the PLS. (An other way to test the results would be to independently verify the practice specialties of individual clinicians, but this could be difficult, or even not possible if the entity does not possess information that would allow it to know the identity of individual physicians.) Extensive testing and updating of the PLS rules has resulted in an 85% agreement between the PLS with the listed data. Using the listed specialty information along with application of the PLS results the ability to identify specialty on 95% of all groupable records within the outcomes database.

The physical system that is used to implement the present invention includes a programmed computer or group of computers with an appropriate database interface to obtain the data that is processed to determine the inferred specialty, and may also include a user interface as well. The system can be used with a general purpose computer or may include some specific purpose hardware. Thus the means used to carry out the present invention includes any kind of known programmable computational computer system. The system may further include the database of records in the outcomes database.

### EXAMPLE OF MORE DETAILED METHODOLOGY

A specialty is assigned to a provider according to the following steps:

1. The provider shall

a. have more then 10 service records in the database;

b. be listed as a clinician; and

c. have greater then 65% of the provider's records containing procedure codes

If the provider does not meet these criteria their specialty is listed as not-available and steps 2 and 3 are skipped. If other information indicates that such a provider is lisp known to be a clinician or a facility, the specialty is listed as such.

2. If all of the following are true:

(NOTE 1: crit_diag_percentage may be read as, ‘The percentage of this provider's diagnoses that fall into the critical care category’. Emerg_proc_percentage may be read as, ‘The percentage of this provider's procedures that fall into the emergency care category’)

(NOTE 2: The meaning of the specialty identifying code used below, such as “endo” or “card”, may be looked up on the attached SPEC_LIST_THRESHOLD.xls table in the column labeled CODE. When the code is used without a ‘diag’ or ‘diagnosis’ identifier it refers to procedures performed by the specialty.)

(crit_diag_percentage+urg_diag_percentage)>0.23)

AND (endo_diag_percentage<0.4)

AND (card_diag_percentage<0.35)

AND (emerg_proc_percentage<0.2) AND (ent_proc percentage<0.1)

AND (pulm_diag_percentage<0.2)

AND (gast_diag_percentage<0.5)

AND (neph_diag_percentage<0.2)

AND (all_diag_percentage<0.5)

AND (inf_diag_percentage<0.2)

Then select the first of the following statements that is true. If none is true, assign specialty as “othr_spc”:

IF (average age of patients<1.0) THEN specialty=‘NEONAT’.

IF (greater than 90% of patients are 18 or under) THEN specialty=‘PED’.

IF (greater than 50% of patients are over 18 OR pimch_diagnosis) THEN specialty=‘INTERN’.

IF (neither of the previous two age criteria is true) THEN specialty=‘GP_FP’.

3. If the conditions under step 2 are not met then assign specialty according to the first of the following statements that is true. If none is true, assign specialty as “othr_spc.”

(NOTE 3: A statement such as ‘IF (all OR all_diagnosis)’ may be read as: ‘IF either the percentage of ALLERGY related procedures or the percentage of ALLERGY related diagnoses surpasses the threshold listed in the attached SPEC_LIST_THRESHOLD.xls table, then the statement is true.’ If a number is included in the statement such as. ‘IF (pod<0.002)’, the statement may be read as ‘IF the percentage of PODIATRY related procedures is less than 0.002’.)

NEONAT:

IF (average age of patients<1.0)

ALLERGY:

IF (all OR all_diagnosis) AND NOT(ent OR ent_diagnosis)

CARDIOL:

IF (card OR card_diagnosis) AND NOT(crdsrg OR crdsrg_diagnosis OR crdend_diagnosis OR emerg OR emerg_diagnosis OR neph OR neph_diagnosis OR pulm OR pulm_diagnosis OR thor OR thor_diagnosis)

SURGERY:

IF (surg AND surg_diagnosis) AND NOT(crdsrg OR crdsrg_diagnosis OR thor OR thor_diagnosis)

CT_SURG:

IF (crdsrg OR crdsrg_diagnosis) AND NOT(derm OR derm_diagnosis OR ent OR ent_diagnosis OR emerg OR emerg_diagnosis OR nesg OR nesg_diagnosis)

OR

IF (thor OR thor_diagnosis) AND NOT(derm OR derm_diagnosis OR ent OR ent_diagnosis OR emerg OR emerg_diagnosis)

CHIRO:

IF (chiro OR chiro_diagnosis) AND NOT(neur OR neur_diagnosis)

DENTIST:

IF (dent)

DERMATOL:

IF (derm OR derm_diagnosis) AND NOT(pod OR pod_diagnosis OR surg OR surg_diagnosis)

ENDOCRIN:

IF (endo OR endo_diagnosis) AND NOT(ent OR neph OR neph_diagnosis)

ENT:

IF (ent OR ent_diagnosis) AND NOT(rad OR rad_diagnosis OR ane OR ane_diagnosis OR surg OR surg_diagnosis OR emerg OR emerg_diagnosis OR rado)

ER_PHYS:

IF (emerg OR emerg_diagnosis)

GASTRO:

IF (gast OR gast_diagnosis) AND NOT(rad OR rad_diagnosis)

INF_DIS:

IF (inf OR inf_diagnosis) AND NOT(emerg OR emerg_diagnosis OR ane OR ane_diagnosis)

NEPHROL:

IF (neph OR neph_diagnosis)

NEUROL:

IF (neur OR neur_diagnosis) AND NOT(nesg OR nesg_diagnosis OR chiro OR chiro_diagnosis OR psyc OR psyc_diagnosis OR rad OR rad_diagnosis OR orsg OR orsg_diagnosis OR ((orsg+rad)>0.04))

NEUR_SRG:

IF (nesg OR nesg_diagnosis) AND (pod<0.002)

OB_GYN:

IF (ob OR ob_diagnosis) AND NOT(endo OR endo_diagnosis OR gast OR gast_diagnosis OR rad OR rad_diagnosis OR ane OR ane_diagnosis OR surg OR surg_diagnosis OR pulm OR pulm_diagnosis OR (avg_age<1.0))

OR

IF (gyn OR gyn_diagnosis) AND NOT(endo OR endo_diagnosis OR gast OR gast_diagnosis OR rad OR rad_diagnosis OR ane OR ane_diagnosis OR surg OR surg_diagnosis OR pulm OR pulm_diagnosis OR (avg_age<1.0))

HEM_ONC:

IF (hemonc OR hemonc_diagnosis ) AND NOT(ob OR ob_diagnosis OR gyn OR gyn_diagnosis OR rad OR rad_diagnosis OR rado)

OPHTHAL:

IF (ophth OR ophth_diagnosis) AND NOT(ent OR ent_diagnosis)

ORTH_SRG:

IF (orsg+rad)>0.04) AND (allsurg>0.1)) AND (rad>pod_diag_percentage) AND (rad<0.5) AND (ob<0.01) AND (gyn<0.01) AND NOT(urol OR urol9) AND (orsg>0.02)

PODIATRY:

IF (pod OR pod_diagnosis) AND (pod_diag_percentage>rad)

PSYCHIAT:

IF (psyc OR psyc_diagnosis)

PULMONAR:

IF (pulm OR pulm_diagnosis) AND NOT(rad OR rad_diagnosis OR hemonc OR hemonc_diagnosis OR surg OR surg_diagnosis OR card OR card_diagnosis OR emerg OR emerg_diagnosis OR (avg_age<1.0))

RAD_ONC:

IF (rado)

RADIOL:

IF (rad OR rad_diagnosis) AND NOT(ob OR ob_diagnosis OR gyn OR gyn_diagnosis)

RHEUM:

IF (rheu OR rheu_diagnosis) AND NOT(chiro OR chiro_diagnosis)

UROLOGY:

IF (urol OR urol_diagnosis)

| | | Procedure | Diagnosis |
|---|---|---|---|
| Code | Description | Threshold | Threshold |
| ALL | ALLERGY AND | 60% | 60% |
| | IMMUNOLOGY | | |
| CARD | CARDIOLOGY | 20% | 35% |
| CHIRO | CHIROPRACTIC | 2% | 2% |
| CRDSRG | CARDIAC SURGERY | 5% | 5% |
| CRIT | CRITICAL CARE | | |
| THOR | THORACIC SURGERY | 5% | 5% |
| DENT | DENTIST | 1% | |
| DERM | DERMATOLOGY | 20% | 20% |
| ENDO | ENDOCRINOLOGY | 30% | 30% |
| ENT | ENT | 10% | 10% |
| EMERG | EMERGENCY MEDICINE | 10% | 10% |
| | PHYSICIAN | | |
| GAST | GASTROENTEROLOGY | 5% | 20% |
| GPFP | GENERAL PRACTICE/FAMILY | | 30% |
| | PRACTICE | | |
| GYN | GYNECOLOGY | 5% | 5% |
| HEMONC | HEMATOLOGY/ONCOLOGY | 20% | 20% |
| INF | INFECTIOUS DISEASE | 20% | 20% |
| IM | INTERNAL MEDICINE | | 30% |
| NEPH | NEPHROLOGY | 10% | 20% |
| NESG | NEUROSURGERY | 5% | 5% |
| NEUR | NEUROLOGY | 10% | 10% |
| OB | OBSTETRICS | 5% | 5% |
| OPHTHAL | OPHTHALMOLOGY | 15% | 10% |
| ORSG | ORTHOPEDIC SURGERY | 10% | 10% |
| POD | PODIATRY | 5% | 5% |
| PSYC | PSYCHIATRY | 80% | 80% |
| PULM | PULMONOLOGY | 10% | 10% |
| RADO | RADIATION ONCOLOGY | 65% | |
| RAD | RADIOLOGY | 20% | 20% |
| RHEU | RHEUMATOLOGY | 10% | 10% |
| SURG | GENERAL SURGERY | 2% | 2% |
| UROL | UROLOGY | 30% | 30% |
| URG | URGENT CARE MEDICINE | 30% | 30% |
| VASC | VASCULAR DISEASE | 30% | 30% |

1. A method comprising:
receiving records of medical procedures;
in an automated manner, using a set of expert rules to determine the specialty of physicians by applying the rules to the records of medical procedures.

2. The method of claim 1, wherein the method includes determining a list of specialties.

3. The method of claim 1, wherein the method includes determining a specialty and substituting the determined specialty when the records listed a specialty as internal medicine.

4. The method of claim 1, wherein the method includes determining a specialty other than radiology when a specialty in the records is listed as radiology.

5. The method of claim 1, wherein the determining includes using the ages of patients.

6. The method of claim 1, wherein the determining includes using procedures.

7. The method of claim 6, wherein the procedures are determined by CPT4 and/or HCPCS codes.

8. The method of claim 1, wherein the determining includes using diagnoses.

9. The method of claim 6, wherein the diagnoses are determined by ICD-9 codes.

10. The method of claim 1, wherein the determining includes using a combination of patient ages, procedures, and diagnoses.

11. A system comprising:
a database for storing records of medical procedures;
a processor programmed to use a set of rules to determine the specialties of physicians by applying the rules to the records of medical procedures.

12. The system of claim 11, wherein the processor determines a specialty and substitutes the determined specialty when the records listed a specialty as internal medicine.

13. The system of claim 11, wherein the processor determines a specialty other than radiology when a specialty in the records is listed as radiology.

14. The system of claim 11, wherein the processor determines a specialty includes using the ages of patients.

15. The system of claim 11, wherein the processor determines a specialty using procedures.

16. The system of claim 15, wherein the procedures are determined by CPT4 and/or HCPCS codes.

17. The system of claim 11, wherein the processor determines a specialty using diagnoses.

18. The method of claim 17, wherein the diagnoses are determined by ICD-9 codes.

19. The system of claim 11, wherein the processor determines a specialty includes using a combination of patient ages, procedures, and diagnoses.
